(19) United States
(12) Patent Application Publication
(10) Pub. No.: US 2013/0060901 A1
(43) Pub. Date: Mar. 7, 2013

(54) SYSTEM FOR INFORMATION MANAGEMENT PROTECTION AND ROUTING

(71) Applicants: Ervin Adrovic, Holzgerlingen (DE); Harald Burose, Gaufelden (DE); Albrecht Schroth, Herrenberg (DE); Kalambur Subramaniam, Bangalore Karnataka (IN); Bernhard Kappler, Herrenberg (DE); Andreas Wuttke, Sindelfingen Baden Wurttemberg (DE); Douglas B. Myers, San Jose, CA (US)

(72) Inventors: Ervin Adrovic, Holzgerlingen (DE); Harald Burose, Gaufelden (DE); Albrecht Schroth, Herrenberg (DE); Kalambur Subramaniam, Bangalore Karnataka (IN); Bernhard Kappler, Herrenberg (DE); Andreas Wuttke, Sindelfingen Baden Wurttemberg (DE); Douglas B. Myers, San Jose, CA (US)

(21) Appl. No.: 13/697,901

(22) PCT Filed: Jun. 16, 2010
(86) PCT No.: PCT/US10/38870

§ 371 Date: Nov. 14, 2012

(51) Int. Cl. G06F 15/16

(52) U.S. Cl. 709/217

(57) ABSTRACT

An information management control system is disclosed. A planning engine executes on a server and receives a protection service level objective. The planning engine dynamically develops a time schedule of data transfer from a source device. The planning engine also develops a subset of nodes suitable to receive the data transfer in accordance with the protection service level objective. A routing engine receives the time schedule and the subset of nodes. The routing engine generates a coordinating set of connected components from a repository of components to route the data transfer from the source device to one of the nodes suitable to receive the data transfer in accordance with the protection service level objective.

### BACKGROUND

Information Management, sometimes abbreviated as “IM,” helps users and entities capitalize on information or data. Information management helps provide e-discovery, regulatory compliance, and records management, and it also provides for information back up and archiving e-mails, files, and applications. Information management can provide for data protection, which includes information access and quick disaster recovery even as the quantity of information grows and also avoids the loss of information. Information management can also provide for routing or delivery of information or documents from selected sources to selected destination in a network including faxes, printers, e-mail, the World Wide Web, and file destinations.

As information continues to grow and networks and infrastructure continues to get more complex, entities search for efficient and cost effective ways to provide information management services. Two areas of concern include protection of information and routing of information. Protection of information and routing of information have become more complex in that so much of network bandwidth, or the availability of storage devices, are stressed for other business uses. Often, archival and storage inefficiently use network resources or inefficiently store documents. The cost of these inefficiencies includes reduced performance in disaster recovery and creating additional stresses on network resources. Information management administrators often spend considerable time and resources on improving protection and storage. In order to meet business demands, many information management solutions employ additional maintenance costs, overheads, or decentralized processes.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a simplified schematic drawing illustrating an operating environment of embodiments of the present disclosure.

FIG. 2 is a schematic drawing illustrating a computing device for use within the operating environment of FIG. 1 and implementing features of the present disclosures.

FIG. 3 is a block diagram illustrating an embodiment of a method of the present disclosure suitable for use with the computing device of FIG. 2 within the operating environment of FIG. 1.

FIG. 4 is a block diagram illustrating an embodiment of a planning engine that can perform a portion of the method of FIG. 3.

FIG. 5 is a block diagram illustrating an embodiment of a routing engine that can perform a portion of the method of FIG. 3.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various exemplary embodiments described herein may be combined with each other, unless specifically noted otherwise.

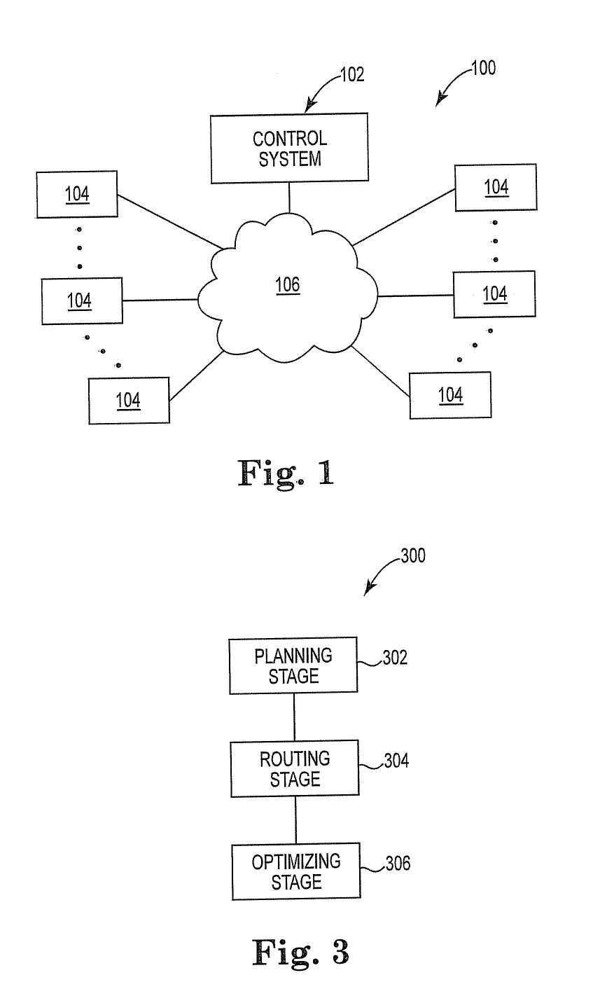

FIG. 1 illustrates one example of an operating environment 100 suitable for incorporating embodiments of the present disclosure, such as an information management environment. A typical operating environment 100 includes a control system 102 coupled to a plurality of nodes 104 on a communications network 106. The control system 102 can include a computer system such as a server, or a group of servers, configured with a computer program to perform a series of information management tasks involving data stored on or otherwise included in the nodes 104. One example includes a centralized control system 102, which can be easily access and used by an administrator, and creates efficiencies over distributed systems. Distributed system can also be used. The control system 102 can be configured to store, archive, copy, move, or the like, the data on the nodes 104. The nodes 104 can include servers, other computing devices, databases, storage areas, or other systems or devices that are configured to facilitate information management tasks performed with the control system 102. The communications network 106 can include the Internet, any type of suitable Area Network such as a local area network (LAN) or the like, a virtual private network, or any suitable telecommunications network.

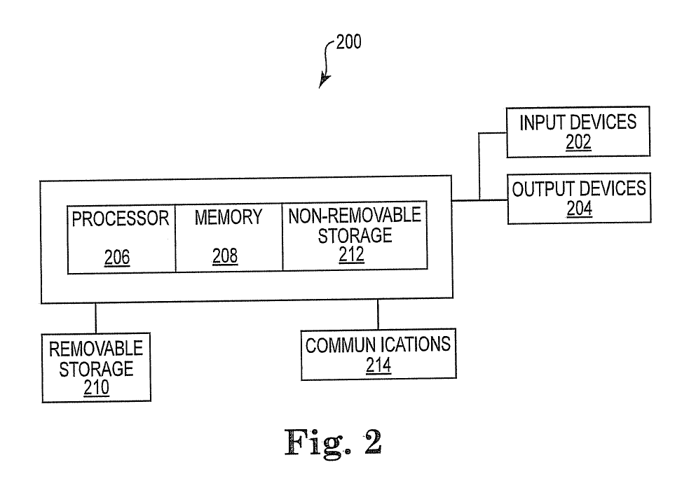

FIG. 2 illustrate an embodiment of a computer system that can be employed in the operating environment 100 as the control system 102 and includes a computing device 200. In one example, the computing device 200 can include or can be coupled to one or more input devices 202, such as keyboard pointing device (e.g., mouse), voce input device, touch input device, or the like. Computing device 200 can also include or can be coupled one or more output devices 204, such as a display, printer, or the like. In a basic configuration, computing device 200 typically includes a processor architecture having at least one processing unit, i.e., processor 206, and memory 208. Depending on the configuration and type of computing device, memory 206 may be volatile, non-volatile, or some combination of the two. The memory 208 can be arranged in a memory hierarchy such as a cache. Computing device 200 can also include additional storage including, but net limited to, magnetic or optical disks or solid state memory, or flash storage devices such as removable storage 210 and non-removable storage 212 for storage of information such as computer readable instructions, data structures, program modules or other data. The computing device 200 can be configured to run an operating system software program that can be stored on the storage media as well as one or more software applications, which make up a system platform. Memory 208, removable storage 210 and non-removable storage 212 are all examples of computer storage media that can be used to store the desired information and that can be accessed by computing device 200. Computer storage media can be part of computing device 200. Computing device 200 can also include one or more communication connections 214 that allow the computing device 200 to communicate with other computers/applications, such as the nodes 104 on the network 106 or other aspects of the control system 102 such as databases, agents, and so on. These other computers/applications can be used to store desired information that can be accessed by computing device 200.

FIG. 3 illustrates an embodiment of a method 300 that can be configured to run on the computing device 200, such as a software application, to form at a least a portion of the control system 102. In a general embodiment, the method can interface with the processor 206 and memory 208 of the computing device to 200 to provide the control system 102. The method 300 includes a protection and routing mechanism that is configured as a planning stage 302, a routing stage 304, and an optimizing stage 306. Each stage 302, 304, 306 can be configured as an expert system or task engine working with the other stages, a single integrated system, or some other combination.

As described, one aspect of the method includes a data protection task, such as the planning stage 302 and the optimizing stage 306. Subtasks in the broad data protection task, such as protection and archival features, have relied on administrator-controlled scheduling to perform copying of data. In order to perform the tasks, administrators often take into account many business or system issues, such as network traffic, needs of the application or data being protected, resource availability, and other protection issues in order to arrive at a suitable schedule. In many previous systems, the administrator has been unable to determine the effectiveness of the scheduling or the protection tasks such as to test for availability of resources or alternative storage mechanisms, or the like, at the time of making copies and protecting data. In many available protection schemes, the administrators specifies both the intended resources and the alternatives, and often without information as to effectiveness of such a scheme.

The method 300 is configured to receive protection objectives, such as from an administrator or the like, as an IM Service Level Objective. In one example, the IM Service Level Objectives can be a Protection Service Level Objective (Protection SLO) for each application or data to be protected. The Protection SLOs are received at the planning stage 302 that determines a time schedule for protecting information, e.g., copying or archiving data, as well as a node pool schedule that describes a plurality of suitable nodes for use during the time schedule. The plural of suitable nodes is useful in case a selected node in the node pool is unavailable because of device failure or other reasons.

The method 300 proceeds to the routing stage 304 to execute the schedules developed with the planning stage 302. Many information management applications route large amounts of data from various sources to various destinations. Previous data movement engines have become very specialized. For example, one engine could be used to perform a restore and will attempt to discover a restore chain while a second engine is used to perform a data back up. As information management tasks are added, such as archival document management, appropriate data movement engines are used or added thus increasing system overhead including development and management issues. The routing stage 304 generates a set of coordinating components that will exchange data. The initiation, application, and monitoring of the components is dynamic and performed with coordinating agents. The previous multitude of data engines can be replaced with a configurable routing stage to efficiently handle information management with significantly reduced overhead.

The method 300 performs the optimizing stage 306, which is configured to analyze the history of the planning stage 302 and the routing stage 304 using speculative rules to predict future planning stages in response to changes in the operating environment that will retrigger features of the planning stage 302. Administrators using the system are thus able to reduce overheads associated with monitoring node or device failures, generating engines, or data growth.

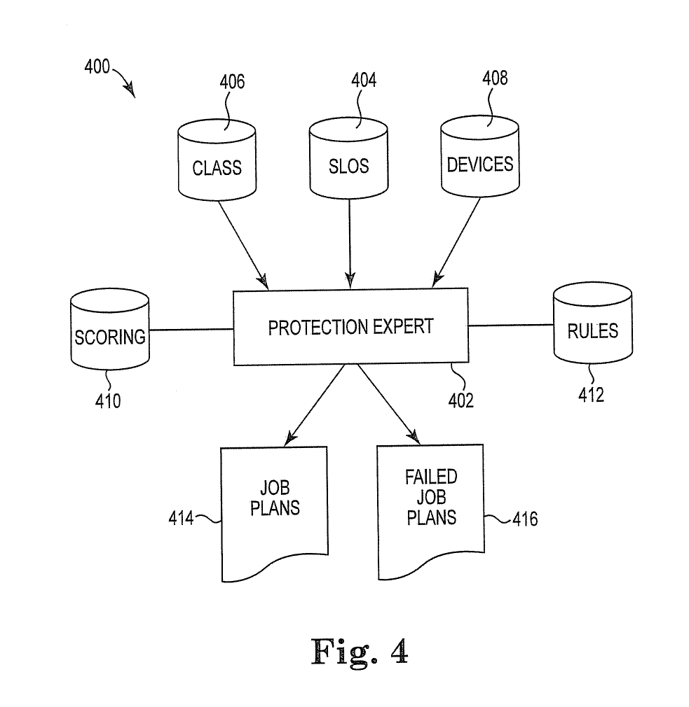

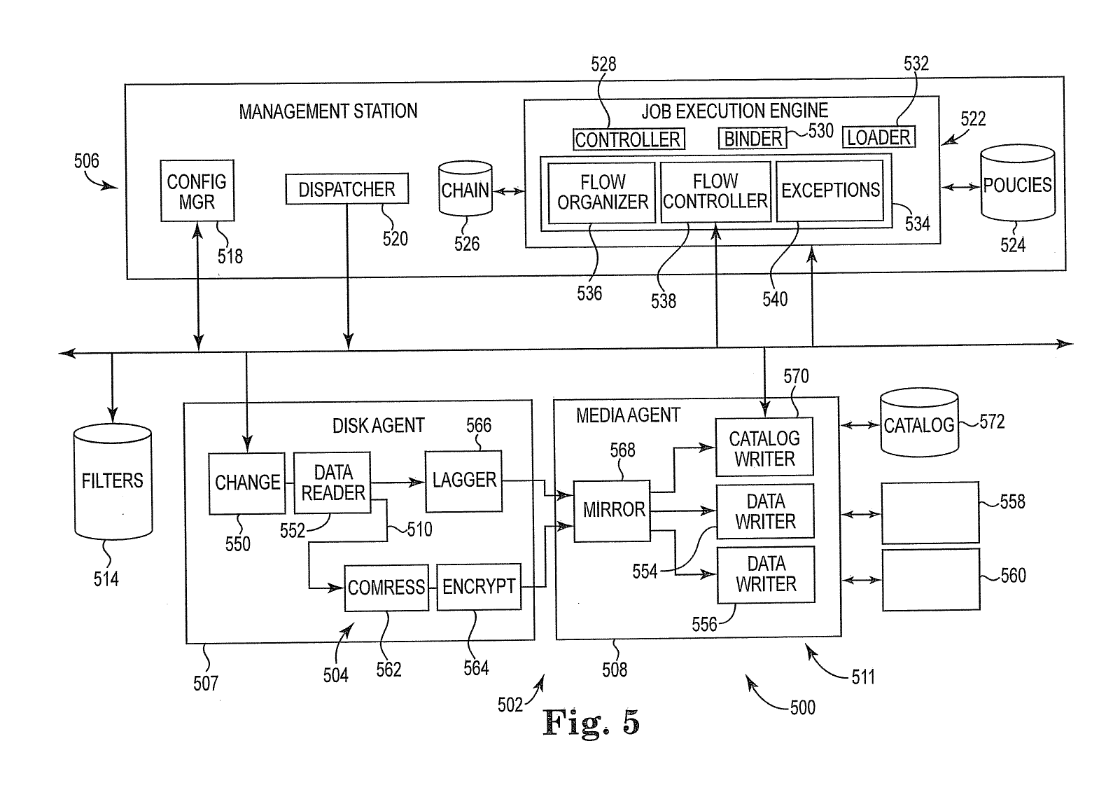

FIG. 4 illustrates a schematic diagram of a protection system 400, or planning engine, suitable for performing the planning stage 302 described above. The protection system includes a protection expert 402, which is configured to operate on the processor 206 and memory 208 of computing device 200. The protection is also configured to receive at least one, but often many, Protection SLOs 404. The protection expert 402 is also configured to receive a set of classes 406 that can be used with the Protection SLOs 404. Further, the protection expert 402 is configured to receive a list of available nodes or devices 408, or devices 408 within nodes, which can be shortened to include a list of available devices 408 corresponding with received classes 406 or particular Protection SLOs 404.

Initially, an administrator can generate a Protection SLO for each application or set of data being protected. For example, an administrator can configure a Protection SLO for a class of applications generally as certain applications corresponding with a function of a business entity. More particularly, the administrator can configure a Protection SLO for a set of applications corresponding to relational databases in the finance department. An administrator can also configure a Protection SLO for data classes, such as all documents that operate with a certain application. More particularly, the administrator can configure a Protection SLO for a set of presentation documents adapted to be run with a presentation application such as that sold under the trade designation of “PowerPoint” from Microsoft Corporation of Redmond, Wash., U.S.A., i.e., a Protection SLO for all PowerPoint presentations. Any newly discovered nodes, servers, or documents as well existing nodes, servers and documents that fall under the Protection SLOs if they match the classes specified in a Protection SLO.

In one example, an administrator can provide a Protection SLO with such information as the importance of the data being protected, timeliness preferences, speed of recovery preferences, disaster recovery preferences, and the like. The example provided does not specify particular nodes or devices for use in the Protection SLO, particular times of data movements so that the protection expert 402 can use flexibility to configure the system to meet the Protection SLOs. The protection expert 402, however, can be provided with hints, suggestions, or background information specific to the operating environment 100, which can automatically be taken into account in the protection expert 402. For example, the information can include a time period when network traffic is low or otherwise suitable for data copy (i.e., backup window), and the like.

The protection expert can also exchange information with a scoring function 410 and a configurable planning rules repository 412. The planning rules repository 412 includes sets of rules for at least one of the stages. Some of these sets of rules are for use with the planning stage 302 in order to calculate the score of different solutions. In addition there can be sets of speculative rules used within the optimization stage 306. Both the scoring function 410 and the configurable rules repository 412 are described below.

When used in the planning stage 302 of FIG. 3, the protection expert 402 determines how often documents are copied or archived and to which pool of nodes are available to store or archive the copies of data as a job plan. The protection expert 402 in the example does not pick a particular node so as not to be hampered in the case of device failure. Factors that can used to develop or influence the choice of nodes in the node pool include recovery preferences, backup window, application or application class, and information specified in the Protection SLO. Also, the protection expert 402 also factors the availability of devices in the device pool to determine an initial job plan. The protection expert 402 implements a rules-based planner from the rules repository 412 to optimize the job plans across all Protection SLOs. Examples of suitable rules-based solvers include business rules management system (BRMS) such as one available under the trade designation “Drools” or a reasoning engine based on a BRMS such as one available under the trade designation of “JBoss Rules,” a productized version of Drools, available from Red Hat, Inc. of Raleigh, N.C., U.S.A.

In addition to the rules derived from the Protection SLOs, the protection engine is using additional rules that either reflect constraints within the environment (such as network band width) device capabilities (such as throughput) or rules that reflect common best practices applied by administrators (such as circumstance where a Storage Area Network is preferred over a local area network for connected devices).

The protection expert 402 computed feasibility score for each alternate solution as a weighted average of the number constraints developed with the scoring function 410. The rule-based solver is used to list all of the generated job plans. On the condition that the protection expert 402 is not able to meet the Protection SLO, for example, the protection expert 402 can indicate a failure and/or recommend alternative solutions for the failed job plans. The protection expert 402 can generate a repository 414 of at least one job plan that succeeded to meet the Protection SLOs and also, in one example, a repository 416 of job plans that failed to meet the Protection SLOs. When a job plan from repository 414 is put into execution, the protection expert 402 will dynamically resolve the order of application back ups to be performed as well as the devices or sets of devices to be used for the data protection. During runtimes in one example, the job plans can be configured with a set of rules to select devices based on availability, network bandwidth, or to minimize maintenance issues, or the like.

FIG. 5 illustrates a schematic diagram of an example unified information management system architecture 500, or routing engine, suitable for performing the routing stage 304 described above and for executing the job plans of repository 414. The architecture 500 includes a filter chain 502 that includes a set of connected together components 504 that perform a coordinated data transfer. The bus architecture also includes a management station 506, such as a server (or servers) on which all of the management components reside, that builds and controls the filter chain 502. The management station 506 serves clients on the network such as network 106 in the operating environment 100) referred to below as “IM clients.”

A set of components 504 that are connected together perform the data transfer or routing stage 304 of method 300. Data transferred also includes meta data. The components 504 are generic and can be dynamically coupled together to execute the job plan in contrast to having to maintain a large set of specialized data movement engines. In one example, the filter chain 502 includes a disk agent 507 and a media agent 508, which are controlled by the management station 506. Data flows from component to component along arrows 510. The connected-together components 504 from a unified information management bus 511 for routing data. Components, or filters, can be selected from a group of existing filters stored in a filter library 514.

The management station 506 includes a configuration manager 518 that deploys the components 504 of the filter chain 502 to the various IM clients on the network 106. The management station 506 also includes a dispatcher 520 that is used to execute a job from a selected job plan. In one example, the dispatcher 520 can prioritize jobs from several received or pending job plans. In one example, the dispatcher 520 interfaces with and receives job plans from the protection system 400. The management station 506 also includes a job execution engine 522.

The job execution engine 522 creates and monitors the filter chain 502. The job execution engine 522 interfaces with a policies repository 524, which contains blueprints of the filter chains 502 and with a state of chain repository 526. The rules repository 412 can also be configured to include policy type rules included in policies repository 524 that can be used within the routing stage 304. The policies can be evaluated by a rules-based system, which can be separate from the rules-based planner, in order to determine if the policies are fulfilled or violated. The job execution engine 522 also includes a controller 528, a binder 530, and loader 532 that are used to perform the respective features of the engine 522. The job execution engine 522 also includes a flow manager 534 to execute the details of the job plan.

The flow manager 534 includes a flow organizer 536, a flow controller 538, and an exception handler 540. The flow organizer 536 uses a blue print of a filter chain for a given operation, creates an instance of the filter chain from the blue print, and assigns various resources to execute the filter chain in an optimal manner. The flow controller 538 is used to execute the instance of filter chain created with the flow organizer 536. The flow controller 638 will set up the bus and all the components 504 along the bus. As a component completes all the tasks allocated to it, the flow controller 538 is responsible for starting other components, assign new tasks or deleting old components in the filter chain 502. The exception handler 640 resolves events on the components that will employ centralized management.

The job execution engine 522 receives the job plan from the protection system 400 and adds further details such as the name of an agent and the client on which that agent is started. The type of job to be executed is used to arrive at the name of the agent. For example, a back up type job includes a change control filter 550 coupled to a data reader 552, which are started at the source client. The factors that govern clients of the data writer filters 554, 556, for example, depends on the accessibility of the destination device, or node, to the source client and other factors considered in the job plan developed with the protection system 400. In the case of a job plan requesting an archival copy, a suitable archival appliance 558, 560, for example, is chosen from node pool. The job execution engine 522 also sets up the intermediate filters in the data transformation on one or more hosts on the network 106, which could be hosts other than those used for the source or destination, i.e., hosts other than used for the data reader 552 and the data writers 554, 556 and are selected based on performance considerations. The data reader 552 can be connected to a compression filter 562 encryption filter 564, which compresses and encrypts the data including the meta data. The data reader filter 552 is also coupled to a logger filter 566, in the example. The logger and encryption filters 566, 564, form the disk agent 506 are couple to a mirror filter 568 of the media agent 508. In addition to being coupled to the data writers 554, 556, the mirror 568 is also coupled to a catalog writer filter 570 which can then write to a catalog 572 on the network 106.

An example blue print of a portion of the simplified filter chain 502 described above can be expressed the following pseudo-code:

<ChainBluePrint name = “Backup Data Flow”>

<SourceNode>

<Name> DataReader </Name>
<Hosts type=variable> Application Class </Hosts>
<DynamicData>

<Pre>

<Gatherer>

GetPhysicalNodeofHostGetPhysicalNodeOfHost </Gatherer>

</Pre>

</SourceNode>
<TransformNode>

<Name> Compress </Name>

</TransformNode>
<DestinationNode>

<Name> DataWriter </Name>

</DestinationNode>
<Assigner> BackupAssigner </Assigner>

The source node is specified in DataReader, but the host on which to start is variable and depends on the application class, from the protection system 400, for which the back up is being performed. The assigner indicates the function used to perform the actual routing between the components 504. Because this can be configured, an administrator can add a new function to be performed a different type of operation if it not already supported.

The flow organizer 536 can complete the blue pint and outputs a job execution plan such as an example expressed in the following pseudo-code:

<Job Execution Plan>

<Name> BackupspecName </Name>
<Session> sessionid </Session>
<SourceNode>

<executable> Data Reader </executable>
<parameters> -fs C </parameters>
<id> drl </daid>
<hostname type=”primary”> h2 </hostname>
<hostname type=”failover”> h3 </hostname>

</SourceNode>
<DestinationNode>

<executable> Data writer </executable>
<id> dwl </daid>
<hostname type=”primary”> h2

<parameters> /dev/nrst1 </parameters>

</hostname>
<hostname type=”failover”> h3

<parameters> /dev/nrst2 </paranieters>

</hostname>

</Destination Node>
<Connections>

<Link>

<source> drl </source>
<destination> dwl </destination>
<trigger> on start </trigger>

</Link>

</Connections>

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An information management control system configured to operate on a network having a plurality of nodes, the control system comprising:
a server having a processor and a memory;
a planning engine configured to execute on the server to dynamically develop a time schedule of data transfer from a source device to a subset of the plurality of nodes suitable to receive the data transfer in accordance with a protection service level objective;
a data storage medium coupled to the server and including a repository of components; and
a routing engine configured to execute on the server to generate a set of connected components from the repository of components to route the data transfer from the source device to one of the subset of the plurality of nodes suitable to receive the data transfer in accordance with the time schedule.

2. The control system of claim 1 and further comprising an optimizing engine configured to execute on the server and use history and speculative rules in response to changes on the network to redevelop a time schedule of data transfer from a source device and redevelop a subset of the plurality of nodes suitable to receive the data transfer in accordance with the protection service level objective and changes to the network.

3. The control system of claim 1 wherein the planning includes a protection expert configured to receive at least the protection service level objective, a set of classes for use with the received protection service level objective, and a set of available nodes from which to develop the subset of the plurality of nodes suitable to receive the data transfer in accordance with the protection service level objective.

4. The control system of claim 3 wherein the set of classes are selected from a group of application classes and data classes.

5. The control system of claim 3 herein the protection expert incorporates a rules-based planner.

6. The control system of claim 5 wherein the protection expert is coupled to a data storage medium including a rules repository.

7. The control system of claim 3 wherein the protection is configured to generate a job plan in accordance with the protection service level objective.

8. The control system of claim 7 wherein the job plan is provided to the routing engine to develop a unified information management bus from the set of connected components.

9. The control system of claim 1 wherein the routing engine includes a management station configured to build and control a filter chain from the set of connected components wherein the data transfer flows from component to component in the filter chain.

10. The control system of claim 9 wherein the routing engine includes a data storage medium coupled to the management station and including a repository of components.

11. The control system of claim 10 wherein the components in the filter chain are selected to perform a data transfer function in accordance with the protection service level objective.

12. The control system of claim 9 wherein the management station includes a job execution engine having a flow organizer to generate the set of connected components from the protection service level objective.

13. The control system of claim 1 wherein the coordinated set of connected components are deployed on clients of the server.

14. A computer readable storage medium operable on a network having a plurality of nodes, the computer readable storage medium tangibly storing computer executable instructions for controlling a computing device to perform a method comprising:
dynamically developing a time schedule of data transfer from a source device to a subset of the plurality of nodes suitable to receive the data transfer in accordance with a received protection service level objective;
generating a coordinating set of connected components from a repository of components to route the data transfer from the source device to one of the subset of the plurality of nodes suitable to receive the data transfer in accordance with the protection service level objective; and
using history and speculative rules in response to changes on the network to redevelop a time schedule of data transfer from a source device and redevelop a subset of the plurality of nodes suitable to receive the data transfer in accordance with the protection service level objective and changes to the network.

15. A computerized method for an information management system including a computing device having a processor and a memory coupled to a network having a plurality of nodes, the method comprising:
receiving at least one protection service level objective into the memory of the computing device;
dynamically developing, with the processor, a time schedule of data transfer from a source device to a subset of the plurality of nodes suitable to receive the data transfer in accordance with a protection service level objective in the memory;
generating, with the processor, a coordinating set of connected components from a repository of components operably coupled to the computing device to route the data transfer from the source device to one of the subset of the plurality of nodes suitable to receive the data transfer in accordance with the protection service level objective; and
using history of the data transfers and speculative rules in response to changes on the network to redevelop a time schedule of data transfer from a source device, with the processor, and redevelop a subset of the plurality of nodes suitable to receive the data transfer in accordance with the protection service level objective and changes to the network, with the processor.
